(19) United States
(12) Patent Application Publication
(10) Pub. No.: US 2015/0016595 A1
(43) Pub. Date: Jan. 15, 2015

(54) RECOMMENDATION, PERSONALIZATION AND PRICING ENGINE BUILT IN WITH A CENTRALIZED TELECOM PRODUCT CATALOG

(71) Applicant: Poone Palli Chandra Yugandhar, Bangalore (IN)

(72) Inventor: Poone Palli Chandra Yugandhar, Bangalore (IN)

(21) Appl. No.: 13/939,299

(22) Filed: Jul. 11, 2013

(51) Int. Cl. H04M 15/00

(52) U.S. Cl. CPC H04M 15/43
USPC 379/114.03

(57) ABSTRACT

An apparatus including a server computer processor, a server computer memory, a computer display, and a user computer interactive device. The server computer processor may be programmed to receive a first plurality of user inputs from the user computer interactive device; select a subset of a set of telecommunications service plans based on the first plurality of user inputs; and display on a computer display information concerning the subset of the set of telecommunications service plans. The server computer processor may be further programmed by the computer program stored in the server computer memory to receive a second plurality of user inputs which modify one or more characteristics of the subset of the set of telecommunications service plans to form a modified subset of telecommunications service plans.

### FIELD OF THE INVENTION

This invention relates to improved methods and apparatus relating to telecommunications computer software.

### BACKGROUND OF THE INVENTION

Most, if not all, known communication service providers (CSP), such as Vodafone (trademarked), AT&T (trademarked) and others, manage a plethora of products or subscription plans to suit the whims and fancies of various customer segments. This becomes even more complex when the CSPs are into multiple lines of businesses such as mobile, fixed line, broadband, DTH (Direct to Home), and IPTV (Internet Protocol Television).

Today, service providers define and manage their products or subscription plans through multiple product catalogs. These catalogs are part of their billing, Intelligent Network (IN), Value Added Services (VAS), and other third party systems. With such an approach, various related components of a single product or subscription plan need to be created in multiple catalogs before it can be commercially launched. Also, in cases where some changes are required to existing products, multiple catalogs need to be updated. Furthermore, the functions of recommendation, personalization, and price control are also scattered. Overall, this restricts a service provider's ability to up-sell, cross-sell, control prices dynamically, and rollout new products faster.

### SUMMARY OF THE INVENTION

One or more embodiments of the present invention provide telecommunications product catalog computer software that enables users of telecommunications services to choose and personalize their subscription plans and products, and also allows the telecommunications service providers to price these offerings dynamically.

In at least one embodiment of the present invention, a unified system, apparatus, and/or method is provided which allows users to select appropriate communication products or subscription plans based on their inputs and refine the selection through personalization. Furthermore, in one or more embodiment, CSPs are able to control prices of the selection through configuration of rules.

One or more embodiments of the present invention provide systems, methods, and/or apparatuses that help subscribers of telecommunication services in their choice for appropriate products or subscription plans. At the beginning of a method in accordance with at least one embodiment of the present invention a server computer processor requests users to input certain information about their likely usage patterns and other preferences.

An apparatus, method, and/or system in accordance with one or more embodiments may include information about the user, user inputs, user historical behavior of usage and usage behavior. Based on user inputs, a recommendation engine narrows down a list of suitable products from a complete set. The recommendation engine accesses this user based information using one or more application program interfaces and provides feedback to the user from a virtual catalog of products available from a number of source catalogs of disparate systems of a communication service provider.

On specifying a selection from the earlier recommendations, another method provides a recommendation of ‘add-on’ or complementary products that the user can select from.

Another method in accordance with an embodiment of the present invention, allows a user to refine the products from feedback provided by defined rules. Users can select products from an available set and can then further personalize various components or constituent elements of the product or subscription plan.

In one or more embodiments of the present invention, personalization of a product and add-on will provide a price to the user, fetched through a built-in pricing engine. The pricing engine is a rules based engine that allows a Communication Service Provider (CSP) to dynamically control the prices of various permutation and combinations selected by the subscribers. The price is based on a method that will take all inputs provided, both—implicit and explicit and then based on rules provide a specific price for the selection to the user. The price can be based on sales channel, geographical location, day of the week, time of the day and other inputs which can be defined in the rules. The selection is then communicated through an Application Program Interface to other systems for service delivery.

An apparatus, method, and/or system in accordance with a further embodiment, may further provide feedback to a communication service provider of various popular and personalized selections opted by the users and may allow for analysis of the same.

In at least one embodiment, an apparatus is provided comprising a server computer processor, a server computer memory, a computer display, and a user computer interactive device. The server computer processor may be programmed by a computer program stored in the server computer memory to receive a first plurality of user inputs from the user computer interactive device; select a subset of a set of telecommunications service plans based on the first plurality of user inputs; and display on a computer display information concerning the subset of the set of telecommunications service plans.

The server computer processor may be further programmed by the computer program stored in the server computer memory to receive a second plurality of user inputs which modify one or more characteristics of the subset of the set of telecommunications service plans to form a modified subset of telecommunications service plans.

The server computer processor may be further programmed by the computer program stored in the server computer memory to retrieve pricing plans for the subset of the set of telecommunications service plans; and modify the pricing plans to form modified pricing plans based on the second plurality of user inputs.

The subset of the set of telecommunications service plans may have only one telecommunications service plan; and the modified subset of the set of telecommunications service plans may have only one telecommunications service plan.

Each of the set of telecommunications service plans may include an amount of text message service usage, a maximum amount of time for voice usage, a maximum amount of time for data usage, a maximum data transfer speed, a contract period, and/or a geographic zone.

In at least one embodiment a method is provided which may include receiving a first plurality of user inputs from a user computer interactive device; storing the first plurality of user inputs in a server computer memory; using a server computer processor to select a subset of a set of telecommunications service plans based on the plurality of user inputs; and displaying on a computer display information concerning the subset of the set of telecommunications service plans.

The method may further include receiving a second plurality of user inputs from the user computer interactive device, wherein the second plurality of user inputs modify one or more characteristics of the subset of the set of telecommunications service plans to form a modified subset of telecommunications service plans; storing the second plurality of user inputs in the server computer memory; and storing the modified subset of telecommunications service plans in the server computer memory.

The method may further include retrieving pricing plans for the subset of the set of telecommunications service plans from the server computer memory; modifying the pricing plans to form modified pricing plans based on the second plurality of user inputs; and storing the modified pricing plans in the server computer memory.

### BRIEF DESCRIPTION OF THE DRAWINGS

FIG. 1 is a block diagram of a user computer and a server computer linked together by the internet for use with an embodiment of the present invention;

FIG. 2 is a block diagram of a method, apparatus, and/or system which includes a recommendation engine, personalization engine, price engine, and product configuration engine in accordance with an embodiment of the present invention;

FIG. 3 is a block diagram of the interaction within the recommendation engine, personalization engine, price engine, and product configuration engine in accordance with an embodiment of the present invention;

FIG. 4 shows a diagram of an image which may be displayed on a user computer display of the user computer of FIG. 1, in accordance with an embodiment of the present invention;

FIG. 5 shows a diagram of an image which may be displayed on the user computer display of the user computer of FIG. 1, in accordance with an embodiment of the present invention; and

FIG. 6 shows a flow chart of a method in accordance with another embodiment of the present invention.

### DETAILED DESCRIPTION OF THE DRAWINGS

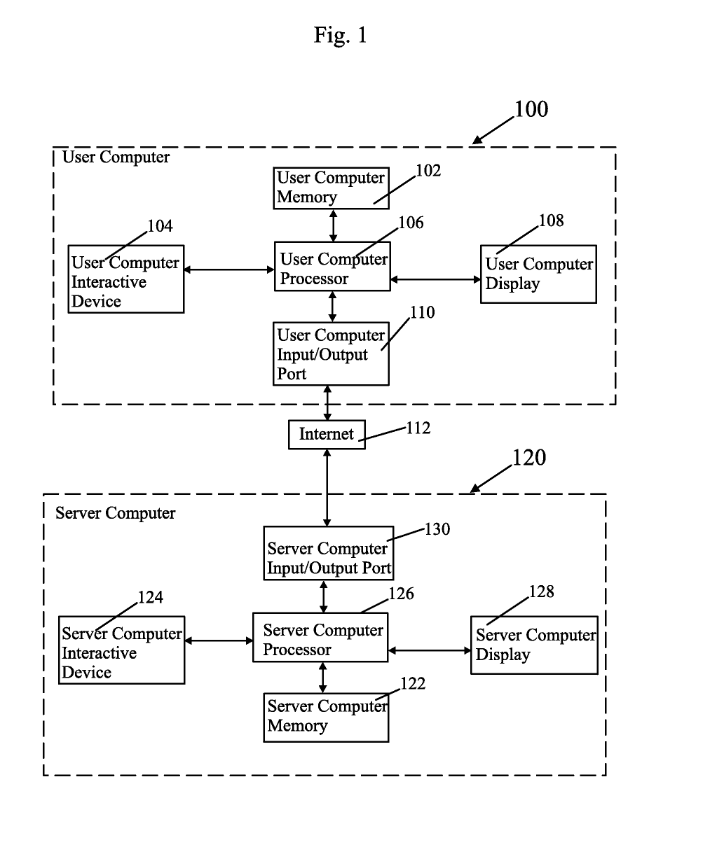

FIG. 1 shows a block diagram of a user computer 100 and a server computer 120, in communication via the internet 112, for use in accordance with one or more embodiments of the present invention. The user computer 100 includes a user computer memory 102, a user computer interactive device 104, a user computer processor 106, a user computer display 108, and a user computer input/output port 110. The user computer interactive device 104 may be a computer touch screen, a computer keyboard, and/or a computer mouse, and/or any other type of computer interactive device.

The server computer 120 includes a server computer memory 122, a server computer interactive device 124, a server computer processor 126, a server computer display 128, and a server computer input/output port 130. The server computer interactive device 124 may be a computer touch screen, a computer keyboard, and/or a computer mouse, and/or any other type of computer interactive device.

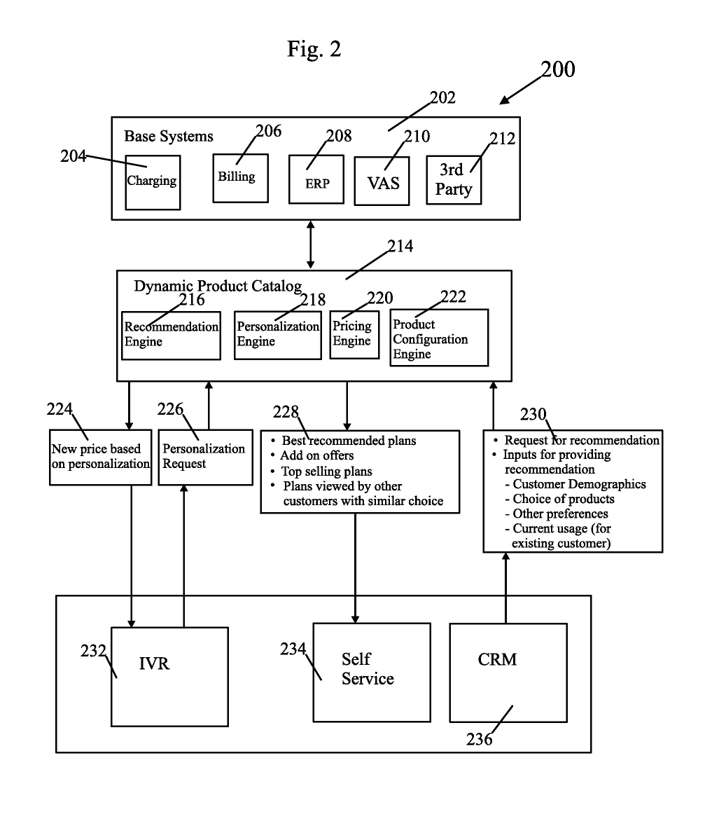

FIG. 2 is a block diagram 200 of a method, apparatus, and/or system which includes a recommendation engine 216, a personalization engine 218, a price engine 220, and a product configuration engine 222. Engines 216, 218, 220, and 222 may be stored in a dynamic product catalog 214 which may be stored in computer memory such as in the server computer memory 122 of FIG. 1. Each of engines 216, 218, 220, and 222 may be implemented by a computer processor executing computer code stored in computer memory, such as the server computer processor 126 executing computer code or programming stored in the server computer memory 122.

Engine 216 may include the server computer processor 126, a computer program stored in the server computer memory 122, and a portion of computer memory in memory 122 in which the computer program is stored. Similarly, each of engines 218, 220, and 222 may include the server computer processor 126, a computer program stored in the computer memory 122, and a portion of the computer memory in memory 122 in which the particular computer program is stored. Typically, each of engines 216, 218, 220, and 222 will have its own computer program and its own portion of computer memory in memory 122.

The block diagram 200 also includes base systems 202. Base systems 202 include charging systems 204, billing systems 206, ERP (enterprise resource planning) systems 208, VAS (Value Added Services) systems 210, and third party systems 212.

Each of systems 204, 206, 208, and 210 may be implemented by a computer processor executing computer code stored in computer memory, such as the server computer processor 126 executing computer code or programming stored in the server computer memory 122.

System or apparatus 204 may include the server computer processor 126, a computer program stored in the server computer memory 122, and a portion of computer memory in memory 122 in which the computer program is stored. Similarly, each of systems or apparatuses 206, 208, 210, and 212 may include the server computer processor 126, a computer program stored in the server computer memory 122, and a portion of the computer memory in memory 122 in which the particular computer program is stored. Typically, each of systems or apparatuses 206, 208, 210, and 212 will have its own computer program and its own portion of computer memory in memory 122.

Each of base systems 204, 206, 208, 210, and 212 have one or more product descriptions stored in computer memory of the particular base system. These product descriptions stored in computer memory of base systems 204, 206, 208, 210, and 212 are inherited using software interfaces by the dynamic product catalog 214 shown in FIG. 2, and/or by the engines 216, 218, 220, and 222, to execute one or more functions of the dynamic catalog 214 and/or engines 216, 218, 220, and 222. The catalog 214 and/or engines 216, 218, 220, and 222 may inherit the product descriptions by the product descriptions being copied from computer memory of one or more of the base systems 202 to computer memory of the dynamic catalog 214 and/or one or more of the engines 216, 218, 220, and 222, as implemented by one or more computer processors of the base systems 202 and/or one or more computer processors of the dynamic product catalog 214 and as programmed by a computer software stored in one or more computer memories of the base systems 202 and/or the dynamic product catalog 214.

The recommendation engine 216 is programmed by computer software stored in it is computer memory to use a computer processor to filter products or subscription plans from a large pool of products based on inputs about a subscriber's preferences, usage patterns, demographics or other such inputs, which may be provided through user computer interactive device 104 and stored in user computer memory 102, and then provided to and stored in server computer memory 122, via internet 112. Based on these inputs, the recommendation engine 216, as implemented by a computer processor such as server computer processor 126, and as programmed by computer software stored in server computer memory 122, causes the display of images of select products, on the user computer display 108, through the internet 112 via user computer processor 106, wherein the select products are likely to suit the subscriber's needs. Examples of products displayed could be subscription plans with monthly rentals and varying tariff for different types of calls, SMSs (Short Message Service texts or Services for sending short message service texts) and internet usage on the phone.

The personalization engine 218 may have the following characteristics. After a subscriber chooses a plan, such as subscription plans with monthly rentals and varying tariff for different types of calls, SMSs (short message service texts or services for sending short message service texts) and internet usage on the phone, through the user interactive device 104, wherein the plan is recommended to a user, such as by displaying on the user computer display 108, via information provided by the server computer processor 126, via the internet 112 to the user computer processor 106. The user then has an option to personalize it further as per his or her requirement such as via a display or menu on the user computer display 108 and/or via the user computer interactive device 104. For example, the user can choose to increase his voice minutes for making telecommunications calls on a cellular phone or number of text messages as per his or her usage of the cellular telephone or smart phone. Accordingly, his or her plan will get priced.

The pricing engine 220 helps a telecommunications operator to set a price to offerings, which will be reflected while a user chooses that offer. The pricing engine 220 also enables a telecommunications operator to apply rules based pricing, based on rules stored in the server computer memory 122, and implemented by the server computer processor 126, to the said offerings. For example, the operator may configure rules through the server computer interactive device 124 and choose that a particular offering should only be shown in a specific geographic location.

The product configuration engine 222 allows a telecommunications operator to configure new products very simply, such as through the server computer interactive device 124. A telecommunications operator can create new offerings and bundles, via server computer interactive device 124, to offer to users instantly. For example, if an operator wants to offer only voice and data services in a particular offering, he can create it using the product configuration engine 222.

The base systems 202 are programmed in the server computer memory 122 to communicate with the dynamic product catalog engines 216, 218, 220, and 222, as implemented by the server computer processor 126.

The block diagram 200 includes an IVR (Interactive Voice Response) block 232, Self Service block 234 and CRM (customer relationship management) block 236. The blocks 232, 234, and 236 are various systems or apparatuses which subscribers of telecommunications services can use to provide inputs to the dynamic product catalog system 214 for recommending their choice of subscription plans. The blocks 232, 234, and 236 may be stored in server computer memory 122, and implemented by server computer processor 126. Using IVR block 232, a user can feed in his inputs, such as through user computer interactive device 104, which may include keys of a cellular phone, by pressing numbers on his cellular telephone in response to questions asked by the IVR system or block 232, which may be part of the server computer 120, implemented by the server computer processor 126, and programmed by computer software stored in computer memory 122. Using self service 234, a user can login to his online account, using user computer interactive device 104 with the telecom service provider and use an internet based computer software application to provide inputs to the dynamic product catalog system 214 of the server computer 120. A user can also use the services of a customer service representative of the telecommunications service provider to provide inputs, from the user computer 100 to the dynamic product Catalog system 214 of the server computer 120 using a CRM (customer relationship management) system 236, via the internet 112.

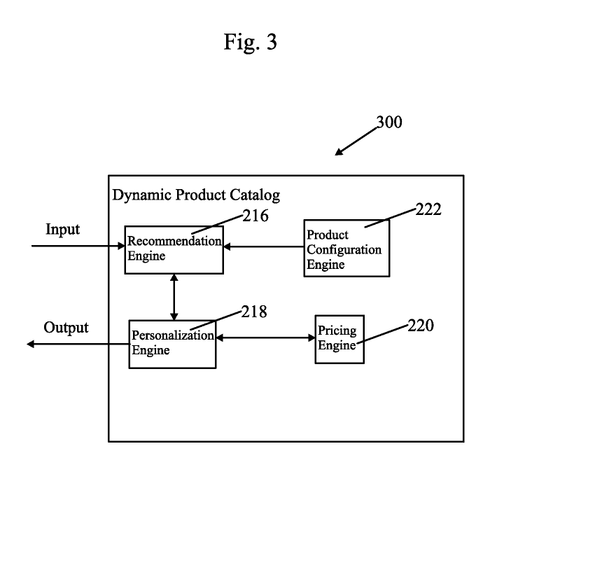

FIG. 3 is a block diagram of the interaction of the recommendation engine 216, personalization engine 218, pricing engine 220, and product configuration engine 222 in accordance with an embodiment of the present invention.

In at least one embodiment, a user enters an input, such as entering his usage information, such as his estimated voice and SMS (short message service texts) usage every month into the user computer interactive device 104, such as by using keys of cellphone or touch screen interface of cellphone or smart phone in response, which is then stored in user computer memory 102 by user computer processor 106 as programmed by a computer program stored in user computer memory 102. The user computer processor 106 is programmed to send the data to the server computer 120 via the internet 112.

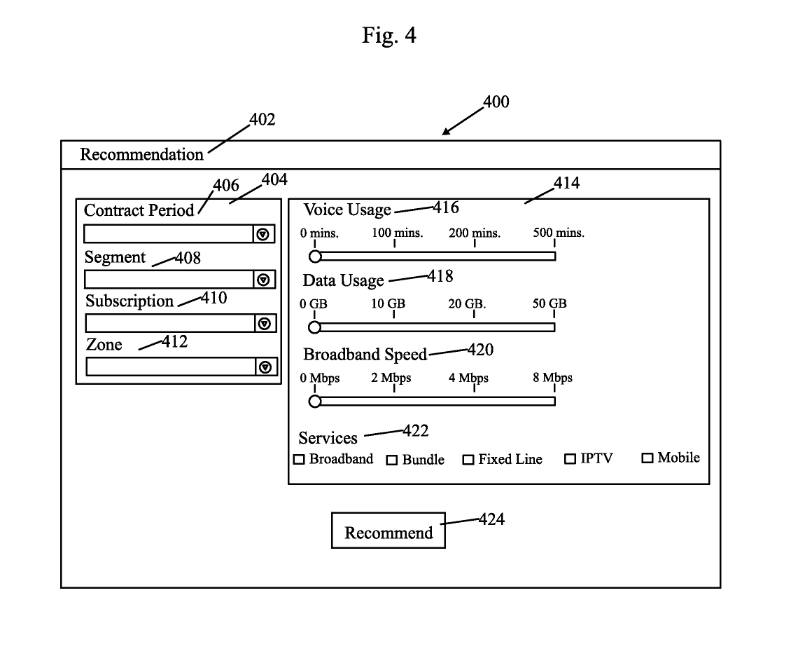

FIG. 4 shows a diagram of an image 400 which may be displayed on the user computer display 108 of the user computer 100 of FIG. 1, in accordance with an embodiment of the present invention. The image 400 includes blocks or fields 402, 404, 414, and 424.

The block or field 404 includes sections 406, 408, 410, and 412. Section 406 shows the heading “Contract Period”, along with a box for entering a contract period for telecommunications services, and a circle, with a small upside down triangle, which can be clicked on to select from a drop down menu a contract period such as one year, two years, or some other period of time. A user using user computer interactive device 104, can enter a contract period the entry box under “Contract Period”. This entered contract period is programmed to be stored in user computer memory 102 by the computer processor 106 and then sent to the server computer processor 126 via internet 112, to be stored in the server computer memory 122.

Section 408 shows the heading “Segment”, along with a box for entering a segment a segment is a category of people which can be defined at the back end for telecommunications services, and a circle, with a small upside down triangle, which can be clicked on to select from a drop down menu such as corporate, individual, or student. A user using user computer interactive device 104, can enter a segment under the entry box under “Segment”. This entered segment is programmed to be stored in user computer memory 102 by the computer processor 106 and then sent to the server computer processor 126 via internet 112, to be stored in the server computer memory 122.

Section 410 shows the heading “Subscription”, along with a box for entering a subscription which is prepaid or postpaid for telecommunications services, and a circle, with a small upside down triangle, which can be clicked on to select from a drop down menu a subscription such as prepaid or postpaid. A user using user computer interactive device 104, can enter a subscription under the entry box under “Subscription”. This entered subscription is programmed to be stored in user computer memory 102 by the computer processor 106 and then sent to the server computer processor 126 via internet 112, to be stored in the server computer memory 122.

Section 412 shows the heading “Zone”, along with a box for entering a geographical zone for telecommunications services, and a circle, with a small upside down triangle, which can be clicked on to select from a drop down menu a zone such as North, South, East or West. A user using user computer interactive device 104, can enter a zone under the entry box under “Zone”. This entered subscription is programmed to be stored in user computer memory 102 by the computer processor 106 and then sent to the server computer processor 126 via internet 112, to be stored in the server computer memory 122.

The box or field 414 includes sections 416, 418, 420, and 422. The section 416 refers to voice usage and allows a user using user computer interactive device 104 to select a number of minutes of voice usage allowed for a telecommunications plan. A user can select, such as by touching or clicking on, the circle under “0 mins.” and move and/or slide the circle along the bar shown in section 416 to set the number of minutes allowed, such as for example, to “100” minutes, “200 minutes” or “500 minutes”. The number of minutes selected for voice usage may then be stored by computer processor 106 in computer memory 102 and then sent to server computer processor 126 and stored in server computer memory 122, as programmed by computer programming stored in the computer memory 102 and/or the computer memory 122.

The section 418 refers to data usage and allows a user using user computer interactive device 104 to select a number of bytes or amount of data for data usage allowed for a telecommunications plan. A user can select, such as by touching or clicking on, the circle under “0 GB” (wherein “GB” is Giga Bytes) and move and/or slide the circle along the bar shown in section 418 to set the number of giga bytes or data usage or amount of data which is allowed to be transferred or downloaded as part of a telecommunications plan, such as for example, to “10 GB”, “20 GB” or “50 GB”. The amount of data usage or amount of data selected for data usage may then be stored by computer processor 106 in computer memory 102 and then sent to server computer processor 126 and stored in server computer memory 122, as programmed by computer programming stored in the computer memory 102 and/or the computer memory 122.

The section 420 refers to broadband speed which will be used and/or selected by a user using user computer interactive device 104 to select a broadband speed for a telecommunications plan. A user can select, such as by touching or clicking on, the circle under “0 Mbps” (wherein “Mbps” is Mega bits per second) and move and/or slide the circle along the bar shown in section 420 to set the number of Mega bits per second for data speed of a telecommunications plan, such as for example, to “0 Mbps”, “2 Mbps”, “4 Mbps”, or 8 “Mbps”. The data speed or broadband speed may then be stored by computer processor 106 in computer memory 102 and then sent to server computer processor 126 and stored in server computer memory 122, as programmed by computer programming stored in the computer memory 102 and/or the computer memory 122.

The section 422 refers to telecommunications services. A user using user computer interactive device 104 can select such as by touch, clicking on, and/or checking a box to the left of the name for the service, one of “Broadband”, “Bundle”, “Fixed Line”, “IPTV”, and/or “Mobile” telecommunications services.

The box or section 424, labeled “Recommend” can be selected, using user computer interactive device 104 to cause the particular telecommunications plan selected with entries in box or field 404 and box or field 414 to be sent from the server computer 120 to the user computer 100.

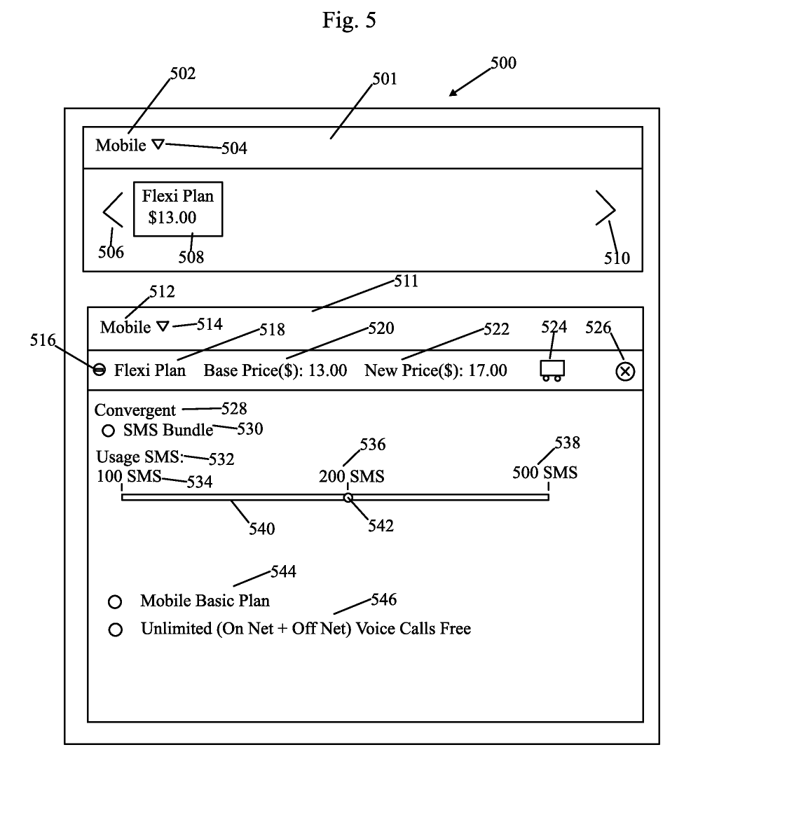

FIG. 5 shows a diagram of an image 500 which may be displayed on the user computer display 108 of the user computer 100 of FIG. 1, in accordance with an embodiment of the present invention. The image 500 may be produced by computer software implementing the personalization engine 218 of dynamic product catalog 214 which may be stored in server computer memory 122 and executed by server computer processor 126. The image 500 includes a section 501 and a section 511.

The section 501 includes text 502 for “Mobile”, and an upside arrow 504 which can be selected using user computer interactive device 104. The text 502 and upside arrow 504 indicate that the user computer display 108 of the user computer 100 of FIG. 1 is displaying products relevant to the mobile business of a particular telecommunications operator. The section 501 also includes a left pointing arrow 506 and a right pointing arrow 510 each of which can be selected using user computer interactive device 104 to scroll through multiple products, if available. The section 501 also includes a section 508 which can be selected by a user using user computer interactive device 104 to see the details of the product selected.

The section 511 includes text 512 for “Mobile”. The section 511 also includes upside down arrow which can be selected using user computer interactive device 104. The text 512 and upside down arrow 514 indicate that the user computer display 108 of the user computer 100 of FIG. 1 is displaying products relevant to the mobile business of the telecommunications operator.

The section 511 further includes button 516 which can be selected to minimize or maximise the viewing of the details of the product, and text 518 for “Flexi Plan”. The section 511 further includes text 520 for “Base Price ($): 13.00” and text 522 for “New Price($): 17.00” which displays the price of a default product and the price of a product after personalization or customization of sub components. The section 511 further includes fields 524 which can be selected to add the product into the shopping cart for purchase and field 526 which can be selected using user computer interactive device 104 to close the view of section 511. The section 511 also includes text 528 for “Convergent”, and a field 530 which includes a button or circle and the text “SMS Bundle”

The section 511 also includes text 532 for “Usage SMS” which specifies how much short message service time the user is entitled to as part of his or her plan. The section 511 also includes text 534, 536, and 538 for how much short message service is permitted under the plan, such as “100 SMS” for (for 100 texts allowed) text 534, “200 SMS” for text 536, and “500 SMS” for text 538. A bar 540 is shown along with a circle or button 542 which sits under the amount of SMS selected such as in this case “200 SMS”.

The section 511 also includes field 544 which includes a button and text 544 for “Mobile Basic Plan”. The section 511 also includes field 546 which includes a button and text 546 for “Unlimited (On Net+Off Net) Voice Calls Free.

The image 500 showcases one or more functions of the personalization engine 218. After a user or subscriber inputs various parameters for recommendation such as 406, 408, 410, 412, 416, 418, 420, 422 of FIG. 4 through the user computer interactive device 104 which is then stored in user computer memory 102 by user computer processor 106, and thereafter supplied to server computer 120, the recommendation engine 216, as executed by the server computer processor 126 causes a name of a product to be displayed by the name of ‘Flexi Plan’ shown in field 508, on the user computer display 108 whose base price is $13. Further details of the “Flexi Plan” are also displayed in the section 511 shown in FIG. 5. This plan includes sub components like ‘SMS Bundle’ identified in field 530, ‘Mobile Basic Plan’ identified in field 544, and ‘Unlimited (On Net+Off Net) Voice Calls Free’, identified in field 546. Out of all these sub components, the Personalization Engine 218 as implemented by computer software stored in server computer memory 122 and executed by server computer processor 126, provides the option of personalizing one sub component, in this example, which is, ‘Usage SMS’ shown by texts or fields 532, 534, 536, 538, 540, and 542. If a user chooses the standard “Flexi Plan” with a default value of 100 SMS, then the price of this plan is $13. If he or she wants 200 SMS shown by text or field 536, included in the plan, he can select and slide, using user computer interactive device 104 the slider or button 542 to 200 SMS position, at 536. If he or she slides it to “200 SMS” position, then the price of the plan changes to $17, which is displayed next to the label ‘New Price’ or text 522 in FIG. 5. The icon of ‘Shopping Cart’ or field 524 can be clicked or selected using user computer interactive device 104 to order this product (i.e. Flexi Plan $13.00 or Flexi Plan $17.00 and the ‘Close’ button or field 526 can be clicked to close this window or image 500 on the user computer display 108 of the user computer 100.

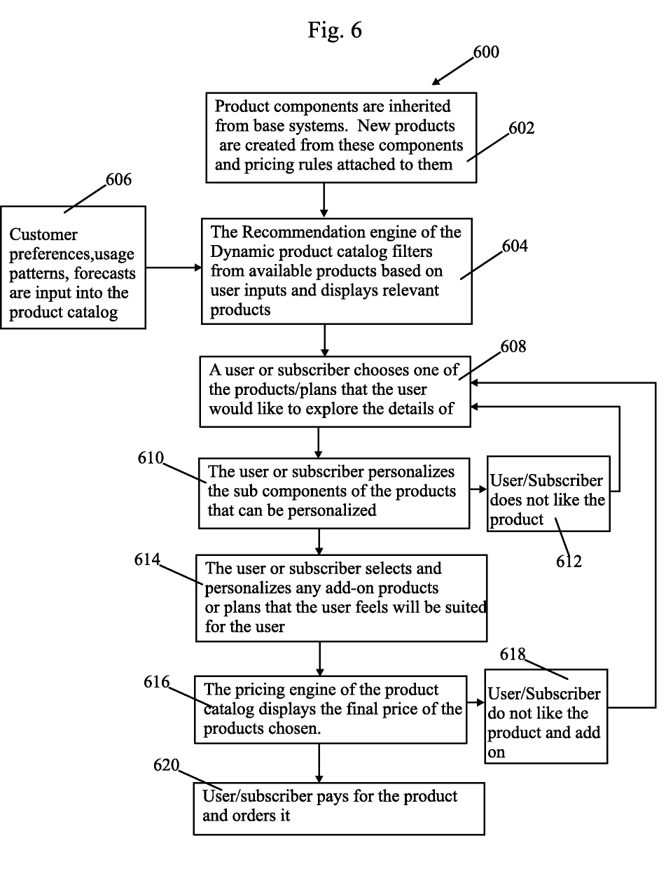

FIG. 6 shows a flow chart 600 of a method in accordance with another embodiment of the present invention. At step 602, product components are inherited by the dynamic product catalog in the server computer memory 122 from base systems 202, which may be stored in a different section of server computer memory 122 or on a different computer memory. The server computer processor 126 may be programmed by computer software stored in server computer memory 122 to cause the product components, such as voice, text, broadband for example, to be copied to the dynamic product catalog from the base systems 202. The server computer processor 126 may also be programmed to create new products, such as a bundle offer of the three product components from the inherited product components and may be programmed to attach or link pricing rules to the new products and to store data related to the new products in the dynamic product catalog of the server computer memory 122.

At step 604 the recommendation engine 216 of the dynamic product catalog 214 may cause, as executed by the server computer processor 126, the filtering of available products based on user inputs provided via user interactive device 104 of the user computer 100, and the recommendation engine 216 may display relevant products on the user computer display 108.

At step 606 customer preferences, usage patterns, and forecasts may be input into the product catalog 214, such as via the user interactive device 104 into the user computer 100, and then supplied to the server computer 120 via the internet 112.

At step 608, a user or subscriber may choose one of the telecommunications products/plans that the user would like to explore the details of, by using the user interactive device 104 of the user computer 100. At step 610, the user or subscriber may personalize the sub components of the products that can be personalized through the user interactive device 104. This may be done through a menu as shown in 414.

If the user/subscriber does not like a particular product, then the process continues at step 612 which loops back to step 608.

If the user/subscriber does like a particular telecommunications product, then at step 614, the user or subscriber selects and personalizes any add-on products or plans that the user feels will be suited for the user

At step 616, the pricing engine 220, which may be executed by the server computer processor 126 as programmed by computer software stored in the server computer memory 122, may display the final price of the telecommunications products chosen on the user computer display 108, via the server computer processor 126, the internet 112, and the user computer processor 106.

At step 618 if the user/subscriber does not like the product and add on, the procedure cycles back to step 608. At step 620, if the user/subscriber does like the telecommunications product and add on, the user/subscriber pays for the product and orders it.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

1. An apparatus comprising:
a server computer processor;
a server computer memory;
a user computer processor;
a user computer memory;
a user computer display; and
a user computer interactive device;
wherein the user computer processor is programmed by a computer program stored in the user computer memory to:
cause a first image to be displayed on the computer display;
wherein the first image includes a first field and a second field;
wherein the first field of the first image allows entry of a first user input of a first plurality of user inputs via the user computer interactive device;
wherein the first user input of the first plurality of user inputs is selected by a user via the user computer interactive device from a first plurality of predetermined choices displayed on the user computer display concerning a first feature of a subset of a set of telecommunications service plans;
wherein the second field of the first image allows entry of a second user input of the first plurality of user inputs via the user computer interactive device;
wherein the second user input of the first plurality of user inputs is selected by a user via the user computer interactive device from a second plurality of predetermined choices displayed on the user computer display concerning a second feature of the subset of the set of telecommunications service plans;
wherein the server computer processor is programmed by a computer program stored in the server computer memory to:
receive the first user input and the second user input of the first plurality of user inputs from the user computer interactive device;
select the subset of the set of telecommunications service plans based on the first user input and the second user input of the first plurality of user inputs;
and display on the user computer display information concerning the subset of the set of telecommunications service plans.

2. The apparatus of claim 1 wherein
the server computer processor is further programmed by the computer program stored in the server computer memory to:
cause a second image to be displayed on the user computer display;
wherein the second image includes a first field;
wherein the first field of the second image allows entry of a further user input via the user computer interactive device;
wherein the further user input is selected by a user via the user computer interactive device from one or more predetermined choices stored in the server computer memory concerning a further feature of the subset of the set of telecommunications service plans;
wherein the server computer processor is further programmed by the computer program stored in the server computer memory to:
receive the further user input which modify one or more characteristics of the subset of the set of telecommunications service plans to form a modified subset of telecommunications service plans.

3. The apparatus of claim 2 wherein
the server computer processor is further programmed by the computer program stored in the server computer memory to:
retrieve pricing plans for the subset of the set of telecommunications service plans;
and modify the pricing plans to form modified pricing plans based on the further user input.

4. The apparatus of claim 2 wherein
the subset of the set of telecommunications service plans has only one telecommunications service plan; and
and the modified subset of the set of telecommunications service plans has only one telecommunications service plan.

5. The apparatus of claim 2 wherein
the further user input selected by a user via the user computer interactive device from one or more predetermined choices stored in the server computer memory concerns the further feature of amount of text message service usage of the subset of the set of telecommunications service plans;
and the one or more predetermined choices is one or more predetermined choices of amount of text message service usage.

6. The apparatus of claim 1 wherein
the first plurality of predetermined choices displayed on the user computer display concerns the first feature of voice usage of the subset of the set of telecommunications service plans; and the first plurality of predetermined choices is a plurality of amounts of time for voice usage.

7. The apparatus of claim 1 wherein
the first plurality of predetermined choices displayed on the user computer display concerns the first feature of data usage of the subset of the set of telecommunications service plans; and the first plurality of predetermined choices is a plurality of amounts of time for data usage.

8. The apparatus of claim 1 wherein
the first plurality of predetermined choices displayed on the user computer display concerns the first feature of maximum data transfer of the subset of the set of telecommunications service plans; and the first plurality of predetermined choices is a plurality of maximum data transfer speeds.

9. The apparatus of claim 1 wherein
the first plurality of predetermined choices displayed on the user computer display concerns the first feature of contract period of the subset of the set of telecommunications service plans; and the first plurality of predetermined choices is a plurality of lengths of time for a contract.

10. The apparatus of claim 1 wherein
the first plurality of predetermined choices displayed on the user computer display concerns the first feature of geographic zone of the subset of the set of telecommunications service plans; and the first plurality of predetermined choices is a plurality of geographic zones.

11. A method comprising the steps of:
causing a first image to be displayed on a user computer display, wherein the first image includes a first field and a second field;
receiving, via the first field of the first image and a user computer interactive device, entry of a first user input of a first plurality of user inputs, wherein the first user input of the first plurality of user inputs is selected by a user via the user computer interactive device from a first plurality of predetermined choices displayed on the user computer display concerning a first feature of a subset of a set of telecommunications service plans;
receiving, via the second field of the first image and the user computer interactive device, entry of a second user input of the first plurality of user inputs, wherein the second user input of the first plurality of user inputs is selected by a user via the user computer interactive device from a second plurality of predetermined choices displayed on the user computer display concerning a second feature of the subset of the set of telecommunications service plans;
storing the first plurality of user inputs in the server computer memory;
using a server computer processor to select the subset of the set of telecommunications service plans based on the first plurality of user inputs;
and displaying on the user computer display information concerning the subset of the set of telecommunications service plans.

12. The method of claim 11 further comprising
causing a second image to be displayed on the computer display, wherein the second image includes a first field;
receiving, via the first field of the second image and the user computer interactive device, entry of a further user input, wherein the further user input is selected by a user via the user computer interactive device from one or more predetermined choices stored in the server computer memory concerning a further feature of the subset of the set of telecommunications service plans;
using the server computer processor to modify one or more characteristics of the subset of the set of telecommunications service plans to form a modified subset of telecommunications service plans based on the further user input;
storing the further user input in the server computer memory; and
storing the modified subset of telecommunications service plans in the server computer memory.

13. The method of claim 12 further comprising
retrieving pricing plans for the subset of the set of telecommunications service plans from the server computer memory;
modifying the pricing plans to form modified pricing plans based on the further user input; and
storing the modified pricing plans in the server computer memory.

14. The method of claim 12 wherein
the subset of the set of telecommunications service plans has only one telecommunications service plan; and
and the modified subset of the set of telecommunications service plans has only one telecommunications service plan.

15. The method of claim 12 wherein
the further user input selected by a user via the user computer interactive device from one or more predetermined choices displayed on the user computer display concerns the further feature of amount of text message service usage of the subset of the set of telecommunications service plans;
and the one or more predetermined choices is one or more predetermined choices of amount of text message service usage.

16. The method of claim 11 wherein
the first plurality of predetermined choices displayed on the user computer display concerns the first feature of voice usage of the subset of the set of telecommunications service plans; and the first plurality of predetermined choices is a plurality of amounts of time for voice usage.

17. The method of claim 11 wherein
the first plurality of predetermined choices displayed on the user computer display concerns the first feature of data usage of the subset of the set of telecommunications service plans; and the first plurality of predetermined choices is a plurality of amounts of time for data usage.

18. The method of claim 11 wherein
the first plurality of predetermined choices displayed on the user computer display concerns the first feature of maximum data transfer of the subset of the set of telecommunications service plans; and the first plurality of predetermined choices is a plurality of maximum data transfer speeds.

19. The method of claim 11 wherein
The first plurality of predetermined choices displayed on the user computer display concerns the first feature of contract period of the subset of the set of telecommunications service plans; and the first plurality of predetermined choices is a plurality of lengths of time for a contract.

20. The method of claim 11 wherein
the first plurality of predetermined choices displayed on the user computer display concerns the first feature of geographic zone of the subset of the set of telecommunications service plans; and the first plurality of predetermined choices is a plurality of geographic zones.
